(19) United States
(12) Patent Application Publication
(10) Pub. No.: US 2026/0112801 A1
(43) Pub. Date: Apr. 23, 2026

(54) APPARATUS AND METHOD FOR TAPING AN ELECTRODE ASSEMBLY OF BATTERY

(71) Applicant: Samsung SDI Co., Ltd., Yongin-si (KR)

(72) Inventor: Chanwoong Park, Yongin-si (KR)

(73) Assignee: Samsung SDI Co., Ltd., Yongin-si (KR)

(21) Appl. No.: 19/314,401

(22) Filed: Aug. 29, 2025

(30) Foreign Application Priority Data
Oct. 23, 2024 (KR) 10-2024-0146211

(51) Int. Cl. H01M 50/595; H01M 10/04

(52) U.S. Cl. CPC H01M 50/595; H01M 10/0404; H01M 2220/20

(57) ABSTRACT

The present disclosure relates to an apparatus and method for taping an electrode assembly of a battery, in which an attachment reference point and a management reference point are unified, and thus there is little risk of degrading adhesive quality due to an increase in size of an electrode assembly. An overlapping section may be placed on a side surface portion, and thus degradation of quality due to tilting does not occur. The apparatus for taping an electrode assembly of a battery includes a first taping unit that attaches a first tape to a partial surface of an electrode assembly of a battery of which an upper side is provided with a terminal part and a second taping unit that attaches a second tape to another surface of the electrode assembly in a state in which the first tape is attached.

### CROSS-REFERENCE TO RELATED APPLICATIONS

This present application claims priority to and the benefit under 35 U.S.C. § 119(a)-(d) of Korean Patent Application No. 10-2024-0146211, filed on Oct. 23, 2024, in the Korean Intellectual Property Office, the entire disclosure of which is incorporated herein by reference.

### FIELD

The present disclosure relates to a battery, and more particularly, to an apparatus for and a method of taping an electrode assembly of a battery.

### BACKGROUND

Batteries include a primary battery and a secondary battery. The battery may include an electrode assembly that may have a positive electrode plate and a negative electrode plate, a can (or a case) accommodating the same, and an external terminal(s) connecting the electrode assembly to an external power source or a load.

A positive electrode tab and a negative electrode tab may be formed on the electrode assembly, and these electrode tabs or related members (e.g., a current collector, a connection member, an auxiliary tab, etc.) are electrically connected to positive electrode and negative electrode terminals or related members (e.g., a rivet terminal, a cap plate, etc.) located on the outside.

The above information disclosed in this Background section is for enhancement of understanding of the background of the present disclosure, and therefore, it may contain information that does not constitute a related (or prior) art.

### SUMMARY

The present disclosure is directed to providing an apparatus for and a method of taping an electrode assembly of a battery, in which an attachment reference point and a management reference point are unified, and thus there is no risk of degrading adhesive quality due to an increase in size of an electrode assembly, and an overlapping section is placed on a side surface portion, and thus degradation of quality due to tilting does not occur.

According to some aspects of the present disclosure, there is provided an apparatus for taping an electrode assembly of a battery including a first taping unit that attaches a first tape to a partial surface of an electrode assembly of a battery of which an upper side is provided with a terminal part and a second taping unit that attaches a second tape to another surface of the electrode assembly in a state in which the first tape is attached.

In some embodiments, the electrode assembly includes an upper end surface portion on which the terminal part is located, a lower end surface portion located at a side opposite to the upper end surface portion, a first surface portion and a second surface portion formed between the upper end surface portion and the lower end surface portion and parallel to one another, and two side surface portions located between the first surface portion and the second surface portion and parallel to one another, the first taping unit attaches the first tape to the first surface portion and portions of the two side surface portions of the electrode assembly, and the second taping unit attaches the second tape to the second surface portion and portions of the two side surface portions of the electrode assembly.

In some embodiments, the first taping unit includes: a base configured to provide a supporting force; a first central adsorption plate installed above the base and configured to horizontally support the electrode assembly while fixedly adsorbing a central portion of the first tape; a plurality of lower pressing rollers installed to be vertically movable at opposite sides with the first central adsorption plate interposed therebetween and configured to press the first tape toward the electrode assembly; and a roller carrier part configured to move the plurality of lower pressing rollers in a horizontal direction and a vertical direction so that the first tape is pressed by the plurality of lower pressing rollers and is attached to the first surface portion and the two side surface portions.

In some embodiments, the roller carrier part includes: a linear guide installed on the base; a slider slidably supported by the linear guide; and a roller actuator mounted on the slider and configured to vertically move a lower pressing roller of the plurality of lower pressing rollers.

In some embodiments, the apparatus further includes a first side adsorption plate configured to fixedly adsorb a portion of the first tape to be vertically movable at a side opposite to the first central adsorption plate with the lower pressing roller interposed therebetween.

In some embodiments, the slider is provided with an adsorption plate height adjusting unit configured to vertically movably support the first side adsorption plate.

In some embodiments, the second taping unit includes: a second central adsorption plate facing the second surface portion of the electrode assembly and configured to fixedly absorb a central portion of the second tape; second side adsorption plates located at opposite sides with the second central adsorption plate interposed therebetween and configured to fixedly adsorb side portions of the second tape; an upper pressing roller installed between the second central adsorption plate and a second side adsorption plate of the second side adsorption plates and configured to press the second tape toward the electrode assembly; and a roller driving unit configured to move the upper pressing roller in a horizontal direction and a vertical direction so that the second tape is pressed by the upper pressing roller and attached to the second surface portion and the portions of the two side surface portions.

In some embodiments, the second taping unit includes: a second central adsorption plate configured to face the second surface portion of the electrode assembly supported by the first taping unit and maintained in a horizontal state and fixedly adsorb a central portion of the second tape; second side adsorption plates located at opposite sides with the second central adsorption plate interposed therebetween and configured to fixedly adsorb side portions of the second tape; an upper pressing roller installed between the second central adsorption plate and a second side adsorption plate of the second side adsorption plates and configured to press the second tape toward the electrode assembly; and a roller driving part configured to move the upper pressing roller in a horizontal direction and a vertical direction so that the second tape is pressed by the upper pressing roller and attached to the second surface portion and the portions of the two side surface portions.

In some embodiments, the second taping unit further includes a support structure configured to provide a supporting force, a height adjusting device supported by the support structure and configured to output a vertical movement force, and a lifting plate located above the base, vertically moved by the height adjusting device, and having the second central adsorption plate, and the roller driving part includes an interval adjusting device installed on the lifting plate and reciprocating brackets coupled to the second side adsorption plate, having an interval therebetween adjusted by the interval adjusting device, and configured to support the upper pressing roller to be vertically movable.

In some embodiments, the roller driving part further includes roller support bodies configured to support a roller to allow a rolling motion and connected to a respective reciprocating bracket of the reciprocating brackets and a lifting cylinder configured to vertically move a respective roller support body of the roller support bodies.

In some embodiments, the interval adjusting device includes: a symmetrical lead screw installed parallel to the lifting plate and axially rotated; a servo motor configured to axially rotate the symmetrical lead screw; and a nut block fixed to each of the reciprocating brackets and engaged with the symmetrical lead screw, and the reciprocating brackets approach one another or move away from one another when the symmetrical lead screw is axially rotated.

In some embodiments, a horizontal guide extending horizontally and having a guide long hole is fixed to each of the roller support bodies, a vertical guide groove extending vertically is formed in the height adjusting device, and the apparatus for taping an electrode assembly of a battery further includes a guide pin inserted into the vertical guide groove while fitted in the guide long hole.

In some embodiments, the lifting plate is further provided with an adsorption plate lifting part configured to vertically move the second central adsorption plate.

In some embodiments, extended portions of the first tape and the second tape extend outward from the lower end surface portion in a state in which the first tape and the second tape are attached to the first surface portion and the second surface portion of the electrode assembly, and the apparatus for taping the electrode assembly of the battery further includes a forming unit configured to fold the extended portions of the first tape and the second tape inward and bring the folded extended portions into close contact with the lower end surface portion of the electrode assembly.

In some embodiments, the extended portions of the first tape and the second tape have a quadrangular shape having long side portions and short side portions, and the forming unit includes: a first forming unit configured to fold the short side portions inward and bring the folded short side portions into close contact with the lower end surface portion; and a second forming unit configured to fold the long side portions inward and bring the folded long side portions into close contact with the lower end surface portion.

According to some aspects of the present disclosure, there is provided a method of taping an electrode assembly of a battery including a primary taping operation of attaching a first tape to a partial surface of an electrode assembly of a battery of which an upper side is provided with a terminal part and a secondary taping operation of attaching a second tape to another surface of the electrode assembly on which the primary taping is completed.

In some embodiments, the electrode assembly includes an upper end surface portion on which the terminal part is located, a lower end surface portion located at a side opposite to the upper end surface portion, a first surface portion and a second surface portion formed between the upper end surface portion and the lower end surface portion and parallel to one another, and two side surface portions located between the first surface portion and the second surface portion and parallel to one another, the primary taping operation is a process of attaching the first tape to the first surface portion and portions of the two side surface portions, and the secondary taping operation is a process of attaching the second tape to the second surface portion and portions of the two side surface portions.

In some embodiments, the first tape and the second tape partially overlap one another on the two side surface portions.

In some embodiments, the method further comprises a forming operation of attaching the first tape and the second tape to a lower end surface portion of the electrode assembly.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The following drawings accompanying the present specification illustrate embodiments of the present disclosure and further describe aspects and features of the present disclosure together with the detailed description of the present disclosure. Thus, the present disclosure should not be construed as being limited to the drawings, in which:

FIG. 1 is a view illustrating a structure of a prismatic secondary battery manufactured through an apparatus for taping an electrode assembly of a battery according to some embodiments of the present disclosure;

FIG. 2 is an exemplary view of a secondary battery module in which secondary batteries of FIG. 1 are arranged;

FIG. 3 is an exemplary view of a secondary battery pack including the secondary battery module of FIG. 2;

FIG. 4 is a conceptual view illustrating the secondary battery pack installed in a vehicle;

FIGS. 5A to 5F are views for sequentially describing a method for taping an electrode assembly of a battery according to some embodiments of the present disclosure;

FIG. 6 is a front view for describing a configuration of a first taping unit in the apparatus for taping an electrode assembly of a battery according to some embodiments of the present disclosure;

FIG. 7 is a plan view of the first taping unit illustrated in FIG. 6;

FIG. 8 is a view for showing a method of operating the first taping unit of FIG. 6;

FIG. 9 is a schematic front view illustrating a configuration of a second taping unit in the apparatus for taping an electrode assembly of a battery according to some embodiments of the present disclosure;

FIGS. 10 and 11 are views for showing an operation of the second taping unit of FIG. 9;

FIG. 12 is a view illustrating a lower end surface portion of the electrode assembly to which first and second tapes are taped;

FIG. 13 is a view for showing a first forming unit that folds a lateral short side portion of FIG. 12;

FIG. 14 is a view illustrating a state in which the short side portion of the electrode assembly of FIG. 12 is folded;

FIG. 15 is a cross-sectional view illustrating a second forming unit that folds a long side portion of FIG. 14;

FIG. 16 is a flowchart illustrating the method for taping an electrode assembly of a battery according to some embodiments of the present disclosure;

FIGS. 17A to 17D are schematic views illustrating a method of attaching a first tape to an electrode assembly; and

FIGS. 18A to 18D are schematic views illustrating a method of attaching a second tape to an electrode assembly.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her technology in the best way. The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, components, and/or groups thereof but do not preclude the presence or addition of one or more other features, integers, steps, operations, elements, components, and/or groups thereof.

Further, to help understand the present disclosure, the accompanying drawings are not illustrated at actual scale(s), but dimensions of some components may be exaggerated. The same reference numerals designate the same elements in different embodiments.

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Although terms such as first and second are used to describe various components, these components are not limited by these terms. These terms are used only to distinguish a first component from a second component, and it is obvious that the first component may be the second component unless otherwise stated.

Throughout the specification, unless otherwise stated, each element may be singular or plural.

Arranging an arbitrary element “above (or below)” or “on (or under)” another element may mean that the arbitrary element may contact the upper (or lower) surface of the element, and another element may also be interposed between the element and the arbitrary element located on (or under) the element.

Further, it will be understood that if an element is referred to as being “on,” “connected to,” or “coupled to” another element, it may be directly on, connected, or coupled to the other element, but still one or more other elements may be “interposed” between the elements or the elements may be “connected to” or “coupled to” one another through still another embodiment.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated. When “C to D” is stated, it means C or more and D or less, unless otherwise specified.

When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

For the purpose of insulation between a can and an electrode assembly, an insulating tape can be attached to an outer surface of the electrode assembly before the electrode assembly is inserted into the can. Taping may be performed on five surfaces of the electrode assembly except for a terminal part. However, it is not easy to accurately attach the tape to the electrode assembly in a short time. In addition, in recent years, management standards related to tape attachment have become more strict. A taping apparatus and method, which are capable of performing more rapid and accurate taping and performing accurate taping even when a size increases, are required. Such a taping apparatus and method are described herein according to some embodiments.

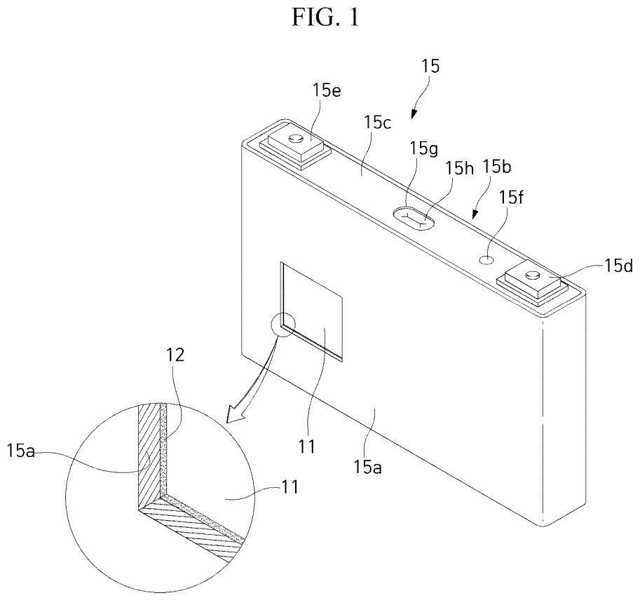

FIG. 1 is a partially cut-away perspective view illustrating a structure of a prismatic secondary battery 15 manufactured through an apparatus for taping an electrode assembly of a battery according to some embodiments of the present disclosure.

A can 15a defines an overall appearance of the prismatic secondary battery, and may be made of a conductive metal, such as aluminum, aluminum alloy, or nickel-plated steel. In addition, the can 15a may provide a space for accommodating an electrode assembly 11 therein.

A cap assembly 15b may include a cap plate 15c that covers the opening of the case 15a. In some examples, the can 15a and the cap plate 15c may be made of a conductive material. Here, a first terminal 15d and a second terminal 15e may be electrically connected to respective positive and negative (or negative and positive) electrodes inside the case, and may be installed to protrude outward through the cap plate 15c.

An electrolyte inlet 15f may be formed in the cap plate 15c, a gas discharge hole 15g may be opened, and a vent, e.g., a gas discharge device 15h may be connected to the gas discharge hole 15g. The gas discharge device 15h can be opened by gas generated inside the battery and can perform a degassing function.

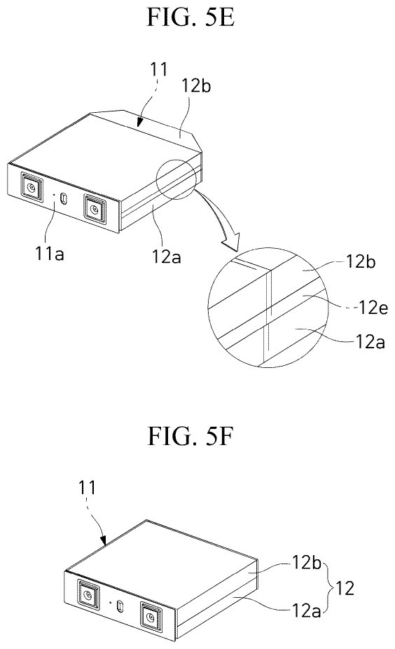

Further, as illustrated in the cut-away perspective view of FIG. 1, a tape 12 may be provided between the electrode assembly 11 and the can 15a. The tape 12 may be applied for insulation between the can 15a from the electrode assembly 11. The tape 12 may include a first tape 12a and a second tape 12b, which will be described herein. As illustrated in FIG. 5C, the first tape 12a and the second tape 12b may have a quadrangular shape and may be attached to the electrode assembly 11.

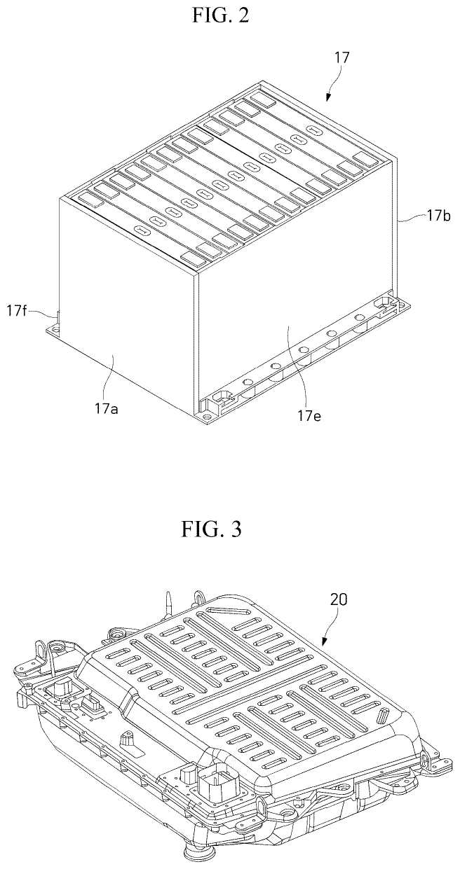

FIG. 2 is an exemplary view of a secondary battery module in which secondary batteries of FIG. 1 are arranged.

With the increase in secondary battery capacity for driving electric vehicles, a secondary battery module 17 may be manufactured by arranging a plurality of secondary battery cells transversely and/or longitudinally and connecting them together. The plurality of secondary batteries may be arranged in a space defined by a pair of facing end plates 17a and 17b and a pair of facing side plates 17e and 17f. The secondary batteries may be arranged in an arrangement direction and number to obtain desired voltage and current specifications.

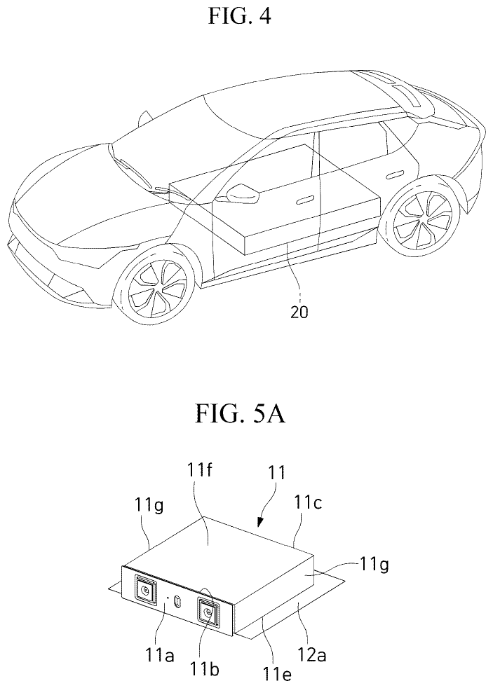

FIG. 3 is an example of a secondary battery pack 20 configured to apply the secondary battery module illustrated in FIG. 2 to an actual product (e.g., an automobile). The secondary battery pack can be manufactured by embedding a plurality of secondary battery modules in a pack housing designed to be mounted on an actual product. The pack housing may include a fastening part and an electrical outlet necessary for mounting on a product. In FIG. 3, for convenience of illustration, components including a bus bar, a cooling unit, and an external terminal for electrically connecting batteries, etc., are not shown. The secondary battery pack may be mounted on a vehicle. The vehicle may be, for example, an electric vehicle, a hybrid vehicle, or a plug-in hybrid vehicle. The vehicle may be a four-wheeled vehicle or a two-wheeled vehicle.

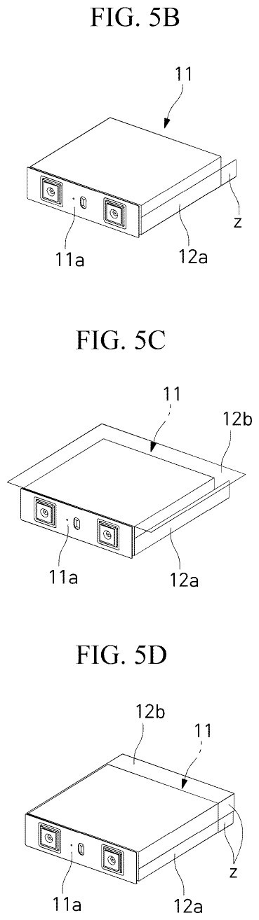

FIG. 4 shows a vehicle that includes the battery pack 20 shown in FIG. 4 on the lower body thereof. The vehicle may operate by receiving power from the secondary battery pack 20 according to some embodiments of the present disclosure.

The materials that can be used in the above secondary battery are as follows.

As the positive electrode active material, a compound capable of reversibly intercalating/deintercalating lithium (e.g., a lithiated intercalation compound) may be used. In detail, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d<0.5, 0≤e≤0.1); LiₐNiG_{b}O₂ (0.90≤a≤1.8, 0.001<b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a secondary battery may include a substrate and a positive electrode active material layer formed on the substrate. The positive electrode active material layer may include a positive electrode active material and may further include a binder and/or a conductive material.

The content of the positive electrode active material may be in a range of about 90 wt % to about 99 wt % on the basis of 100 wt % of the positive electrode active material layer, and the content of the binder and the conductive material may be in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99.5 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent can act as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and combinations thereof and may be used alone or in combination of two or more.

In addition, when a carbonate-based solvent is used, a mixture of cyclic carbonate and chain carbonate may be used.

Depending on the type of lithium secondary battery, a separator may be present between the positive electrode and the negative electrode. As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on one another.

FIGS. 5A to 5F show a view for describing a schematic concept related to secondary battery exterior taping according to some embodiments of the present disclosure.

Taping an electrode assembly of a battery according to the illustrated embodiment relates to attaching a first tape 12a and a second tape 12b to an outer surface of the electrode assembly 11 for a prismatic secondary battery. The electrode assembly 11 may have a substantially hexahedral shape. The electrode assembly 11 may include an upper end surface portion 11b, a lower end surface portion 11c, a first surface portion 11e, a second surface portion 11f, and side surface portions 11g.

The upper end surface portion 11b may be a surface to which a terminal part 11a is fixed. The terminal part 11a is an element in which the electrode assembly 11 is connected to an electrode tab. Further, the lower end surface portion 11c is a surface located at an opposite side to the upper end surface portion 11b. The lower end surface portion 11c may correspond to a bottom surface of the can 15a.

Further, the first surface portion 11e and the second surface portion 11f are flat surfaces formed between the upper end surface portion 11b and the lower end surface portion 11c and parallel to one another. In FIG. 5A, the first surface portion 11e may be a bottom surface of the electrode assembly 11, and the second surface portion 11f may be a top surface of the electrode assembly 11. Further, the side surface portions 11g are two surfaces located between the first surface portion 11e and the second surface portion 11f and parallel to one another. The side surface portions 11g are surfaces perpendicular to the first surface portion 11e or the second surface portion 11f.

Meanwhile, the first tape 12a and the second tape 12b may have a shape of a quadrangular plate and may have the same size. An adhesive may be applied to one surface of each of the first tape 12a and the second tape 12b.

The first tape 12a may be attached to the first surface portion 11e, portions of the two side surface portions 11g, and a portion of the lower end surface portion 11c. Further, the second tape 12b may be attached to the second surface portion 11f, portions of the two side surface portions 11g, and a portion of the lower end surface portion 11c. The first tape 12a and the second tape 12b may overlap one another (e.g., each other) on the side surface portions 11g. Reference numeral 12e in FIG. 5E is an overlapping portion.

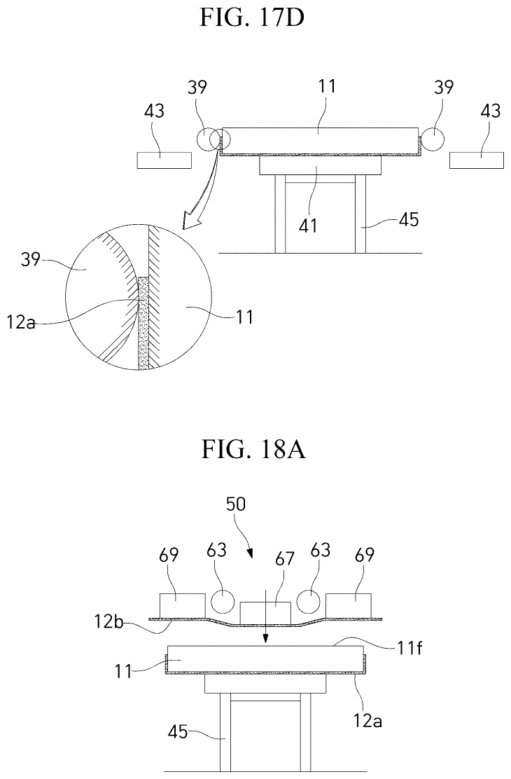

The method of taping an electrode assembly of a battery according to the present embodiments may include a primary taping operation 103, a secondary taping operation 105, and a forming operation 107 (as described in relation to FIG. 16).

The primary taping operation 103 is a process of attaching the first tape 12a to the first surface portion 11e and the portions of the two side surface portions 11g. As illustrated in FIG. 5A, the primary taping operation 103 is a process of spreading the first tape 12a, placing the electrode assembly 11 thereon, folding end portions of the first tape 12a in a width direction upward, and bringing the end portions of the first tape 12a into close contact with the two side surface portions 11g. FIG. 5B illustrates a state in which the first tape 12a is completely attached to the electrode assembly 11. As illustrated in FIG. 5B, a portion of a rear end portion of the first tape 12a extends outward from the lower end surface portion 11c. For convenience of description, the extending portion is referred to as an extended end portion Z. The extended end portion Z may be attached to the lower end surface portion 11c through the forming operation 107.

After the first tape 12a is completely attached, the process proceeds to the secondary taping operation 105. As illustrated in FIG. 5C, the secondary taping operation 105 is a process of spreading the second tape 12b on an upper surface of the electrode assembly 11, then folding both end portions of the second tape 12b downward, and attaching both the end portions to the side surface portions 11g. FIG. 5D illustrates a state in which secondary taping is completed.

The forming operation 107 is a process of folding the extended end portion Z and attaching the extended end portion Z to the lower end surface portion 11c. A description of the forming operation 107 will also be made herein. FIG. 5F illustrates a state after the forming operation 107 is completed. It may be seen that the electrode assembly 11 is completely surrounded by the two tapes.

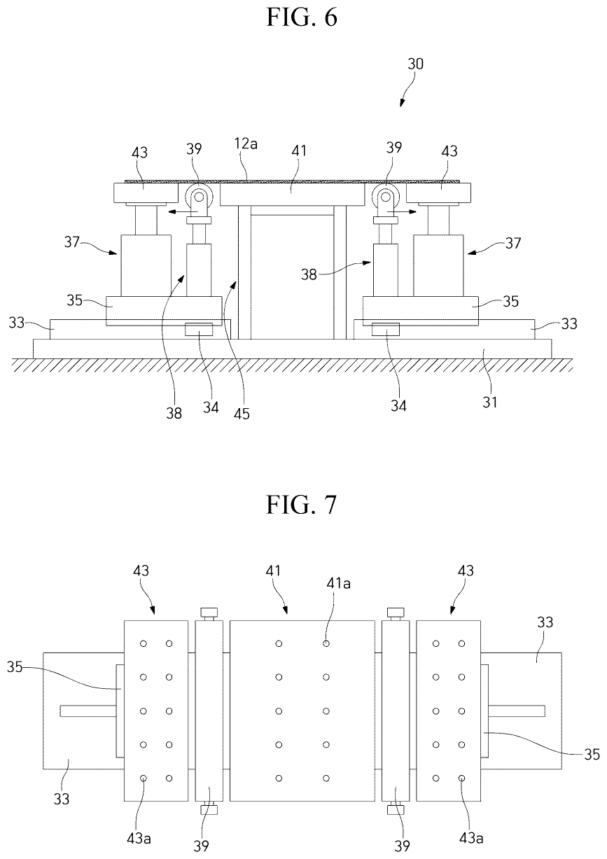

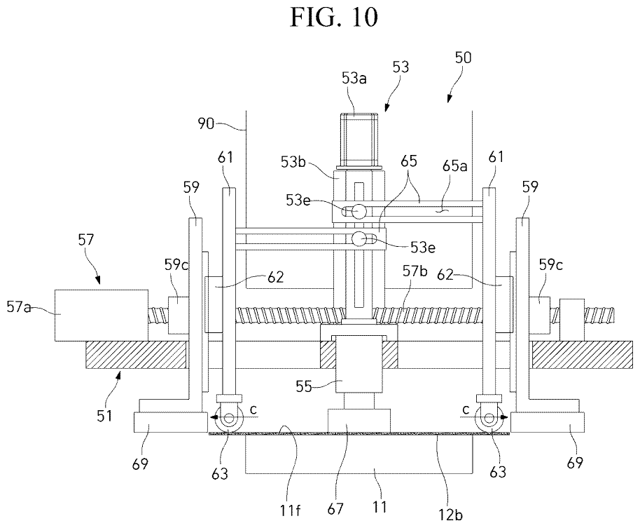

Meanwhile, the apparatus for taping an electrode assembly of a battery according to the present embodiments includes a first taping unit 30 and a second taping unit 50 (as described in relation to FIGS. 6 and 9). The first taping unit 30 may attach the first tape to a partial surface of the electrode assembly for a prismatic secondary battery on which the terminal part is mounted. Further, the second taping unit 50 may attach the second tape to another surface of the electrode assembly in a state in which the first tape is attached.

That is, the first taping unit 30 may serve to attach the first tape 12a to the first surface portion 11e of the electrode assembly 11, and the second taping unit 50 may serve to attach the second tape 12b to the second surface portion 11f of the electrode assembly 11.

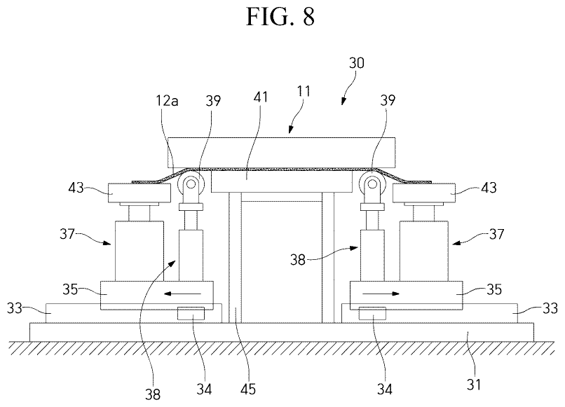

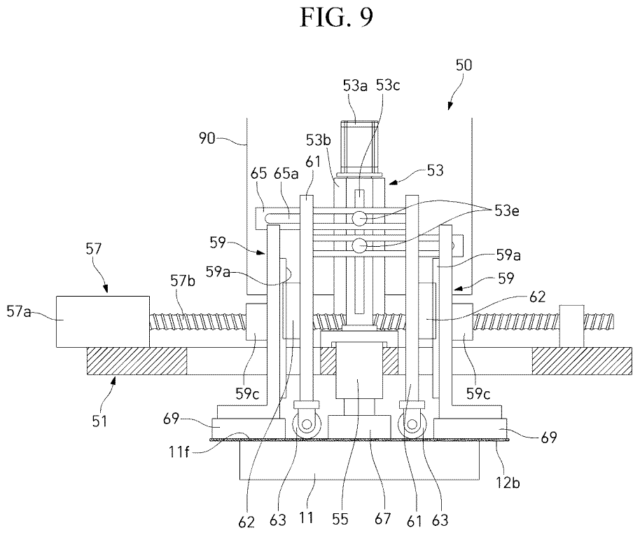

FIG. 6 is a front view for showing a configuration of a first taping unit in the apparatus for taping an electrode assembly of a battery according to some embodiments of the present disclosure. FIG. 7 is a plan view of the first taping unit illustrated in FIG. 6. Further, FIG. 8 is a view for showing a method of operating the first taping unit of FIG. 6.

The first taping unit 30 may attach the prepared first tape 12a to the first surface portion 11e and the portions of the two side surface portions 11g of the electrode assembly 11.

The first taping unit 30 may include a base 31, a pedestal 45, a first central adsorption plate 41, a first side adsorption plate 43, a plurality of lower pressing rollers 39, and a roller carrier part.

The base 31 may be a plate-shaped member providing a supporting force and may have the pedestal 45 in an upper central portion thereof. The pedestal 45 is a structure that supports the first central adsorption plate 41. The first central adsorption plate may be installed above the base.

The first central adsorption plate 41 may be a plate-shaped member that fixedly adsorbs a central portion of the first tape 12a provided from the outside while horizontally supporting the electrode assembly. To this end, a plurality of adsorption holes 41a may be formed in the first central adsorption plate 41. The first central adsorption plate 41 may be connected to an external vacuum pump. The adsorption holes 41a may fixedly adsorb the first tape 12a. In addition, the electrode assembly 11 may be seated on the first central adsorption plate 41. The reason why the electrode assembly 11 may be taped while horizontally laid is for stability of the center of gravity and a load.

The lower pressing rollers 39 are installed to be vertically movable on opposite sides with the first central adsorption plate 41 interposed therebetween and to press the first tape 12a toward the first surface portion 11e of the electrode assembly 11. The lower pressing roller 39 may move in a horizontal direction and a vertical direction by the roller carrier part.

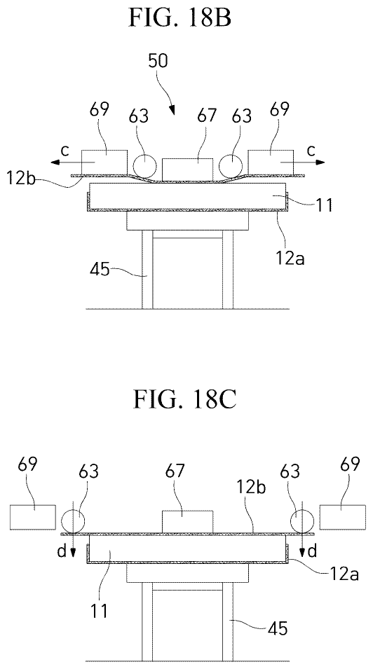

Further, the roller carrier part may move the lower pressing roller 39 in the horizontal direction and the vertical direction, and thus the first tape 12a may be pressed by the lower pressing roller 39 and attached to the first surface portion 11e and the two side surface portions 11g of the electrode assembly 11. That is, the lower pressing roller 39 can be moved in a direction of arrow a and a direction of arrow b of FIGS. 17B and 17C. FIG. 17D illustrates a state in which the first tape 12a is completely in close contact with the electrode assembly 11.

The roller carrier part may include a linear guide 33, a slider 35, and a roller actuator 38. The linear guide 33 may be fixed onto the base 31 and may reciprocate the slider 35 in the horizontal direction using a slide motor 34. The linear guides 33 may be installed on opposite sides with the pedestal 45 interposed therebetween. The sliders 35 may move in a direction away from one another or in a direction closer to one another. The slider may be slidably supported by the linear guide, and the roller actuator may be mounted on the slider.

The roller actuator 38 is an element vertically installed above each slider 35 and may vertically move the lower pressing roller 39. The lower pressing roller 39 may be raised by the roller actuator 38 in a direction of arrow b of FIG. 17C and may attach the first tape 12a to the side surface portions 11g of the electrode assembly 11.

Further, the first side adsorption plates 43 may be provided on opposite sides of the first central adsorption plate 41 with the lower pressing roller 39 interposed therebetween. The first side adsorption plate 43 may be vertically moved by a height adjusting unit while maintained in a horizontal state. The first side adsorption plate 43 may fixedly adsorb a side portion of the first tape 12a while installed on left and right sides of the first central adsorption plate 41. A central portion of the first tape 12a is fixedly adsorbed to the first central adsorption plate 41, and left and right ends of the first tape 12a are adsorbed to the first side adsorption plate 43. A plurality of adsorption holes 43a may also be formed in the first side adsorption plate 43. The first side adsorption plate 43 may also be connected to the external vacuum pump.

An adsorption plate height adjusting unit may be an adsorption plate actuator 37 installed vertically on the slider 35. The adsorption plate height adjusting unit may be configured to vertically movably support the first side adsorption plate. A height of the first side adsorption plate 43 may be adjusted by the adsorption plate actuator 37. FIG. 8 illustrates a state in which the first side adsorption plates 43 on both sides are lowered while adsorbing the first tape 12a.

In some embodiments, the second taping unit 50 may attach the second tape 12b to the second surface portion 11f and the two side surface portions 11g of the electrode assembly 11.

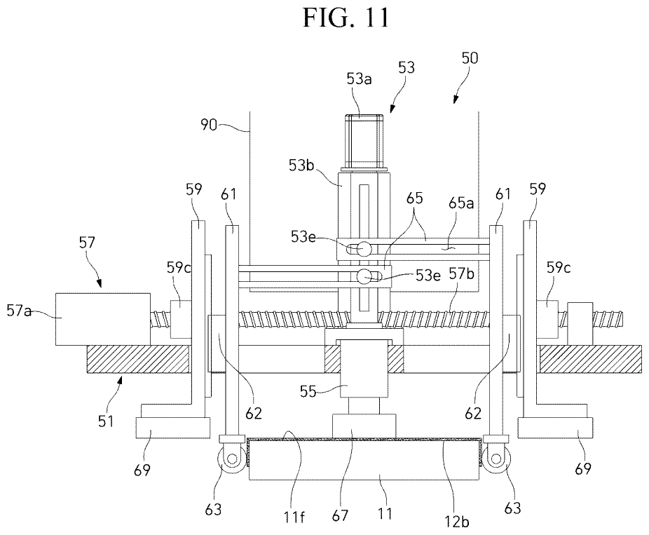

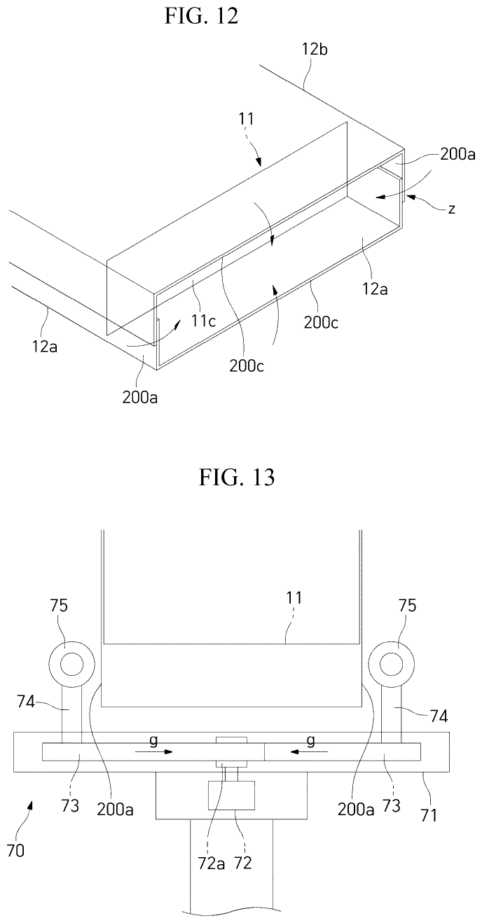

FIG. 9 is a schematic front view illustrating a configuration of a second taping unit 50. FIGS. 10 and 11 are views for describing an operation of the second taping unit of FIG. 9.

As illustrated, the second taping unit 50 may include a support structure 90, a height adjusting device 53, a lifting plate 51, a second central adsorption plate 67, a second side adsorption plate 69, an upper pressing roller 63, and a roller driving part.

The support structure 90 may fix the height adjusting device 53 so that the height adjusting device 53 may vertically move the lifting plate 51.

The height adjusting device 53 may output a vertical movement force while supported by the support structure 90. The height adjusting device 53 may include a body 53b and a servo motor 53a. The body 53b may be coupled to the lifting plate 51 and may provide a vertical guide groove 53c to a front surface thereof. A guide pin 53e is fitted into the vertical guide groove 53c. The guide pin 53e may vertically move while inserted into the vertical guide groove 53c.

The servo motor 53a may adjust a height of the lifting plate 51 through the body 53b. When the lifting plate 51 is lowered, an interval adjusting device 57 and a reciprocating bracket 59 supported by the lifting plate 51 may be lowered together. When the lifting plate 51 is raised, the second side adsorption plate 69 may also be raised.

The lifting plate 51 may be a plate-shaped member maintained in a horizontal state and may be repeatedly lowered or raised above the base 31. The lifting plate 51 may be vertically moved by the height adjusting device 53.

The interval adjusting device 57 may be provided on the lifting plate 51. The interval adjusting device 57 may serve to repeatedly increase or decrease an interval of the reciprocating bracket 59. The interval adjusting device 57 may include a symmetrical lead screw 57b, a servo motor 57a, and a nut block 59c.

The lead screw 57b may be horizontally installed above the lifting plate 51 (e.g., parallel to the lifting plate) and may axially rotate in both directions by the servo motor 57a. Threads formed on an outer circumferential surface of the lead screw 57b may be symmetrical to one another with respect to a center thereof in a longitudinal direction. For example, based on a center of the drawing, a left side may be a left screw thread and a right side may be a right screw thread. The nut block 59c may transmit a rotational force of the lead screw to the reciprocating bracket 59 while fixed to the reciprocating bracket 59. As a result, the reciprocating brackets 59 may repeat a forward and backward movement approaching one another or away from one another by the interval adjusting device 57.

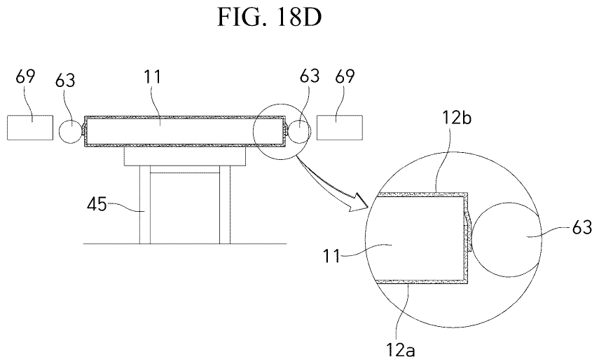

The second central adsorption plate 67, as illustrated in FIGS. 18A to 18D, may be positioned vertically above the second surface portion 11f of the electrode assembly 11 waiting horizontally and may fixedly adsorb a central portion of the second tape 12b. The second central adsorption plate 67 may be connected to the external vacuum pump (not illustrated) and may fixedly adsorb the second tape 12b using a provided vacuum pressure. The second central adsorption plate 67 may face the first surface portion in some embodiments.

The second central adsorption plate 67 may independently, vertically move while supported by a central actuator 55. The central actuator 55 may serve as an adsorption plate lifting part for vertically moving the second central adsorption plate 67.

The second side adsorption plates 69 may be located opposite to one another with the second central adsorption plate 67 interposed therebetween and may fixedly adsorb side portions of the second tape 12b. The side portion of the tape means a portion of the second central adsorption plate 67, which is not adsorbed. The second side adsorption plate 69 may also be connected to the external vacuum pump. The second side adsorption plate 69 may be fixed to a lower end portion of the reciprocating bracket 59. The reciprocating bracket 59 is connected to the lead screw 57b through the nut block 59c.

In addition, vertical guide rails 59a may be provided on both the reciprocating brackets 59. The vertical guide rail 59a may guide vertically movable movement of a roller support body 61, which may be configured to support a roller to allow a rolling motion. A lifting cylinder 62 that vertically moves the roller support body 61 may be provided between the roller support body 61 and the reciprocating bracket 59.

The roller support body 61 may be a member having the upper pressing roller 63 at a lower end thereof and may be vertically moved by the lifting cylinder 62.

The upper pressing roller 63 may be installed between the second central adsorption plate 67 and the second side adsorption plate 69 and may serve to press and attach the second tape 12b toward the electrode assembly 11.

Meanwhile, the roller driving part may move the upper pressing roller 63 in a horizontal direction and a vertical direction so that the second tape 12b is pressed by the upper pressing roller 63 and attached to the second surface portion 11f and portions of the side surface portions 11g. That is, the upper pressing roller 63 is opened in a direction of arrow c of FIG. 18B and then lowered in a direction of arrow d of FIG. 18C.

FIG. 10 illustrates a state in which the upper pressing roller 63 is open in the direction of arrow c. Further, FIG. 11 illustrates a state in which the upper pressing roller 63 is lowered vertically downward.

The roller driving unit may include the interval adjusting device 57, the reciprocating bracket 59, and the lifting cylinder 62. The description of the interval adjusting device, the reciprocating bracket, and the lifting cylinder is the same as that described above.

Further, a horizontal guide 65 may be fixed to the roller support body 61. The horizontal guide 65 may extend horizontally and provide a guide long hole 65a. The guide long hole 65a is perpendicular to the vertical guide groove 53c. The guide pin 53e is located at an intersection between the guide long hole 65a and the vertical guide groove 53c. The guide pin 53e may be inserted into the vertical guide groove 53c while fitted in the guide long hole 65a. The guide pin 53e may synchronize a horizontal movement and a vertical movement of both the roller support bodies 61. That is, the two roller support bodies 61 may be simultaneously moved by the same distance.

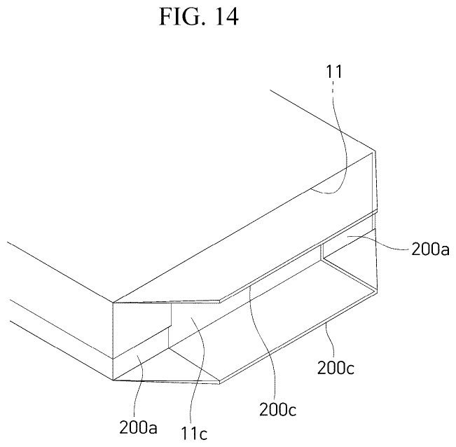

FIG. 12 is a view illustrating a lower end surface portion of the electrode assembly to which the first tape 12a and the second tape 12b are taped. As illustrated, portions of the first tape 12a and the second tape 12b extend in a direction away from the lower end surface portion 11c. The reason why the extended end portion Z is left is to cover the lower end surface portion 11c. The extended end portion Z has a quadrangular shape having long side portions 200c and short side portions 200a.

The apparatus for taping an electrode assembly of a battery according to the present embodiments may further include a forming unit for folding the extended end portion Z inward and bringing the extended end portion Z into close contact with the lower end surface portion 11c. Further, a first forming unit 70 and a second forming unit 80 may be applied as the forming unit.

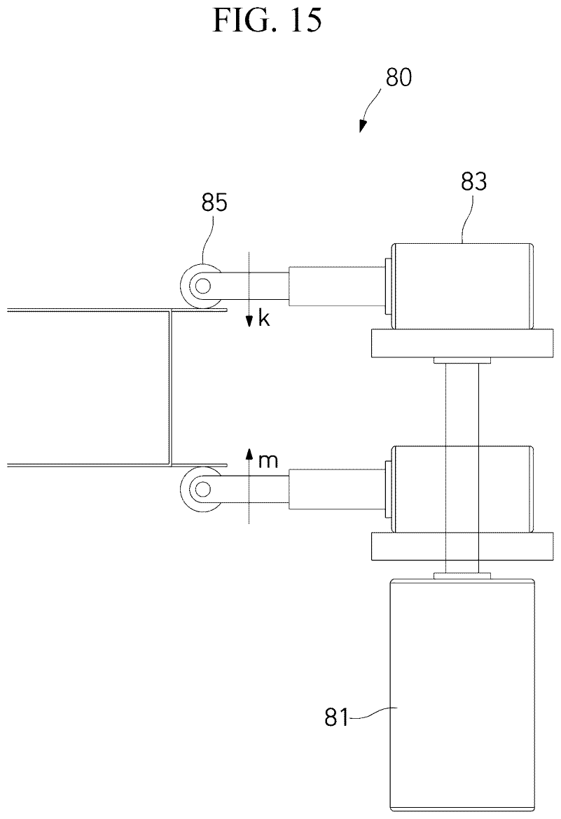

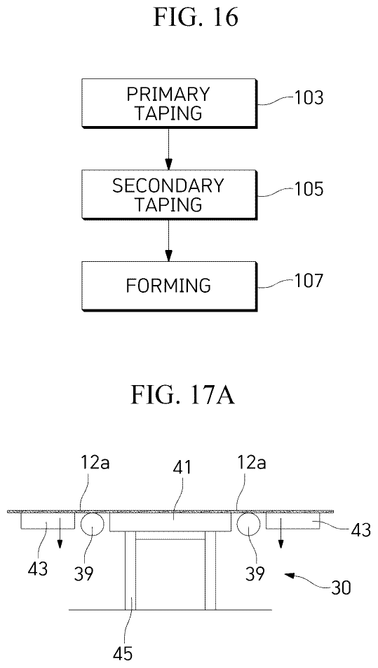

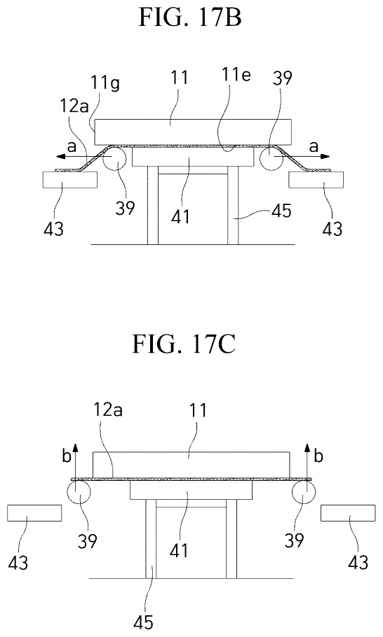

The first forming unit 70, shown in FIG. 13, may fold the short side portions 200a inward and may bring the short side portions 200a into close contact with the lower end surface portion 11c. FIG. 14 illustrates a state in which the short side portions 200a are folded and attached to the lower end surface portion 11c. Further, the second forming unit 80, shown in FIG. 15, may fold the long side portions 200c inward and bring the long side portions 200c into close contact with the lower end surface portion 11c.

FIG. 13 is a view for showing the first forming unit 70 that folds a lateral extended end portion of FIG. 12. FIG. 14 is a view illustrating a state in which a lateral short side portion of the electrode assembly of FIG. 12 is folded.

The first forming unit 70 may include a housing 71, a pair of rack gears 73, a built-in motor 72, and a driving gear 72a, extension bars 74, and forming rolls 75.

The housing 71 is a member movable by an external transfer arm (not illustrated) and accommodates the rack gears 73 therein. Two rack gears 73 form a pair and are engaged with the driving gear 72a. The driving gear 72a may be rotated by the built-in motor 72 and may linearly move the rack gears 73 in a direction opposite to a direction of arrow g. The extension bars 74 may extend outward from the housing 71 while fixed to the rack gears 73 and may rotatably support the forming rolls 75.

When the rack gears 73 are moved in the direction of arrow g in a state in which the forming rolls 75 are positioned outside the short side portions 200a, the forming rolls 75 move inward to fold the short side portions 200a and to bring the folded short side portions 200a into close contact with the lower end surface portion 11c.

FIG. 15 is a cross-sectional view illustrating the second forming unit 80 that folds the long side portions 200c of FIG. 14 inward.

As illustrated, the second forming unit 80 may include a vertical cylinder 81, a horizontal cylinder 83, and a forming roll 85. The vertical cylinder 81 may vertically move the horizontal cylinder 83 while supporting the horizontal cylinder 83. Further, the horizontal cylinder 83 may support the forming roll 85 while supported by the vertical cylinder 81.

A position of the forming roll 85 may be adjusted in the vertical direction and the horizontal direction by the vertical cylinder 81 and the horizontal cylinder 83. The forming roll 85 may be lowered in a direction of arrow k and raised in a direction of arrow m, so that the long side portions 200c are folded and attached to the lower end surface portion 11c.

FIG. 16 is a flowchart illustrating the method for taping an electrode assembly of a battery according to some embodiments of the present disclosure. FIGS. 17A to 17B are schematic views illustrating a method of attaching a first tape to an electrode assembly. FIGS. 18A to 18D are schematic views illustrating a method of attaching a second tape to an electrode assembly.

As illustrated, the method of taping an electrode assembly of a battery according to the present embodiments may include a primary taping operation 103, a secondary taping operation 105, and a forming operation 107.

The primary taping operation 103 is a process of attaching the first tape 12a to a portion of the electrode assembly 11, e.g., the first surface portion 11e, and the portions of the two side surface portions 11g.

To perform the primary taping operation 103, first, the first tape 12a is correctly positioned on the first central adsorption plate 41 and the first side adsorption plate 43 (first tape correct location process). In this configuration, the first central adsorption plate 41 and the first side adsorption plate 43 may vacuum-adsorb the first tape 12a.

Thereafter, the electrode assembly 11 is seated on the first tape 12a using a gripper (correct location process). In this configuration, as illustrated in FIG. 17B, the first side adsorption plate 43 may be lowered.

Next, the lower pressing roller 39 is moved in the direction of arrow a of FIG. 17B so that the lower pressing roller 39 brings the first tape 12a in close contact with the first surface portion 11e of the electrode assembly 11 (first surface portion taping process). After the first surface portion taping process is completed, the lower pressing roller 39 is raised in the direction of arrow b of FIG. 17C and brings the first tape 12a into close contact with the side surface portions 11g (side surface portion taping process). The primary taping operation 103 may be completed through the above process.

The secondary taping operation 105 is a process of attaching the second tape 12b to the other surface of the electrode assembly 11 on which the primary taping is completed, e.g., the second surface portion 11f and the portions of the side surface portions 11g.

To perform the secondary taping operation 105, the second tape 12b is adsorbed using the second central adsorption plate 67 and the second side adsorption plate 69, and as illustrated in FIGS. 18A to 18 DB, the adsorbed second tape 12b is seated on the second surface portion 11f of the electrode assembly 11 (second tape correct location process).

Next, the upper pressing roller 63 may be moved in the direction of arrow c of FIGS. 18A to 18 DB and attaches the second tape 12b to the second surface portion 11f (second surface portion taping process).

After the second surface portion taping process is completed, the upper pressing roller 63 is lowered in the direction of arrow d and brings the second tape 12b into close contact with the side surface portions 11g (side surface portion taping process). The secondary taping operation 105 may be completed through the side surface portion taping process. After the primary taping operation 103 and the secondary taping operation 105 are completed, the first tape 12a and the second tape 12b partially overlap one another on the side surface portions 11g.

The forming operation 107 may include a process of folding the short side portions 200a and the long side portions 200c of the extended end portion Z and bringing the short side portions 200a and the long side portions 200c into close contact with the lower end surface portion 11c using the first forming unit 70 and the second forming unit 80.

In an apparatus and method for taping an electrode assembly of a battery according to the present disclosure, there is little risk of degrading adhesive quality due to an increase in size of an electrode assembly, and an overlapping section is placed on a side surface portion, and thus degradation of quality due to tilting does not occur.

Although the present disclosure has been described above with respect to embodiments thereof, the present disclosure is not limited thereto. Various modifications and variations can be made thereto by those skilled in the art within the spirit of the present disclosure.

What is claimed is:

1. An apparatus for taping an electrode assembly of a battery comprising:
a first taping unit configured to attach a first tape to a partial surface of the electrode assembly of the battery on which a terminal part is mounted; and
a second taping unit configured to attach a second tape to another surface of the electrode assembly in a state in which the first tape is attached.

2. The apparatus for taping the electrode assembly of the battery as claimed in claim 1, wherein:
the electrode assembly includes an upper end surface portion on which the terminal part is located, a lower end surface portion located at a side opposite to the upper end surface portion, a first surface portion and a second surface portion formed between the upper end surface portion and the lower end surface portion and parallel to one another, and two side surface portions located between the first surface portion and the second surface portion and parallel to one another,
the first taping unit attaches the first tape to the first surface portion and portions of the two side surface portions of the electrode assembly, and
the second taping unit attaches the second tape to the second surface portion and portions of the two side surface portions of the electrode assembly.

3. The apparatus for taping the electrode assembly of the battery as claimed in claim 2, wherein the first taping unit includes:
a base configured to provide a supporting force;
a first central adsorption plate installed above the base and configured to horizontally support the electrode assembly while fixedly adsorbing a central portion of the first tape;
a plurality of lower pressing rollers installed to be vertically movable at opposite sides with the first central adsorption plate interposed therebetween and configured to press the first tape toward the electrode assembly; and
a roller carrier part configured to move the plurality of lower pressing rollers in a horizontal direction and a vertical direction so that the first tape is pressed by the plurality of lower pressing rollers and is attached to the first surface portion and the two side surface portions.

4. The apparatus for taping the electrode assembly of the battery as claimed in claim 3, wherein the roller carrier part includes:
a linear guide installed on the base;
a slider slidably supported by the linear guide; and
a roller actuator mounted on the slider and configured to vertically move a lower pressing roller of the plurality of lower pressing rollers.

5. The apparatus for taping the electrode assembly of the battery as claimed in claim 4, further comprising a first side adsorption plate configured to fixedly adsorb a portion of the first tape to be vertically movable at a side opposite to the first central adsorption plate with the lower pressing roller interposed therebetween.

6. The apparatus for taping the electrode assembly of the battery as claimed in claim 5, wherein the slider is provided with an adsorption plate height adjusting unit configured to vertically movably support the first side adsorption plate.

7. The apparatus for taping the electrode assembly of the battery as claimed in claim 2, wherein the second taping unit includes:
a second central adsorption plate facing the second surface portion of the electrode assembly and configured to fixedly absorb a central portion of the second tape;
second side adsorption plates located at opposite sides with the second central adsorption plate interposed therebetween and configured to fixedly adsorb side portions of the second tape;
an upper pressing roller installed between the second central adsorption plate and a second side adsorption plate of the second side adsorption plates and configured to press the second tape toward the electrode assembly; and
a roller driving unit configured to move the upper pressing roller in a horizontal direction and a vertical direction so that the second tape is pressed by the upper pressing roller and attached to the second surface portion and the portions of the two side surface portions.

8. The apparatus for taping the electrode assembly of the battery as claimed in claim 3, wherein the second taping unit includes:
a second central adsorption plate configured to face the second surface portion of the electrode assembly supported by the first taping unit and maintained in a horizontal state and fixedly adsorb a central portion of the second tape;
second side adsorption plates located at opposite sides with the second central adsorption plate interposed therebetween and configured to fixedly adsorb side portions of the second tape;
an upper pressing roller installed between the second central adsorption plate and a second side adsorption plate of the second side adsorption plates and configured to press the second tape toward the electrode assembly; and
a roller driving part configured to move the upper pressing roller in a horizontal direction and a vertical direction so that the second tape is pressed by the upper pressing roller and attached to the second surface portion and the portions of the two side surface portions.

9. The apparatus for taping the electrode assembly of the battery as claimed in claim 8, wherein the second taping unit further includes a support structure configured to provide a supporting force, a height adjusting device supported by the support structure and configured to output a vertical movement force, and a lifting plate located above the base, vertically moved by the height adjusting device, and having the second central adsorption plate, and
wherein the roller driving part includes an interval adjusting device installed on the lifting plate and reciprocating brackets coupled to the second side adsorption plate, having an interval therebetween adjusted by the interval adjusting device, and configured to support the upper pressing roller to be vertically movable.

10. The apparatus for taping the electrode assembly of the battery as claimed in claim 9, wherein the roller driving part further includes roller support bodies configured to support a roller to allow a rolling motion and connected to a respective reciprocating bracket of the reciprocating brackets and a lifting cylinder configured to vertically move a respective roller support body of the roller support bodies.

11. The apparatus for taping the electrode assembly of the battery as claimed in claim 10, wherein the interval adjusting device includes:
a symmetrical lead screw installed parallel to the lifting plate and axially rotated;
a servo motor configured to axially rotate the symmetrical lead screw; and
a nut block fixed to each of the reciprocating brackets and engaged with the symmetrical lead screw,
wherein the reciprocating brackets approach one another or move away from one another when the symmetrical lead screw is axially rotated.

12. The apparatus for taping the electrode assembly of the battery as claimed in claim 10, wherein:
a horizontal guide extending horizontally and having a guide long hole is fixed to each of the roller support bodies,
a vertical guide groove extending vertically is formed in the height adjusting device, and
the apparatus for taping an electrode assembly of a battery further includes a guide pin inserted into the vertical guide groove while fitted in the guide long hole.

13. The apparatus for taping the electrode assembly of the battery as claimed in claim 9, wherein the lifting plate is further provided with an adsorption plate lifting part configured to vertically move the second central adsorption plate.

14. The apparatus for taping the electrode assembly of the battery as claimed in claim 2, wherein extended portions of the first tape and the second tape extend outward from the lower end surface portion in a state in which the first tape and the second tape are attached to the first surface portion and the second surface portion of the electrode assembly, and
wherein the apparatus for taping the electrode assembly of the battery further includes a forming unit configured to fold the extended portions of the first tape and the second tape inward and bring the folded extended portions into close contact with the lower end surface portion of the electrode assembly.

15. The apparatus for taping the electrode assembly of the battery as claimed in claim 14, wherein the extended portions of the first tape and the second tape have a quadrangular shape having long side portions and short side portions, and
wherein the forming unit includes:
a first forming unit configured to fold the short side portions inward and bring the folded short side portions into close contact with the lower end surface portion; and
a second forming unit configured to fold the long side portions inward and bring the folded long side portions into close contact with the lower end surface portion.

16. A method for taping an electrode assembly of a battery comprising:
a primary taping operation of attaching a first tape to a partial surface of an electrode assembly of a battery on which a terminal part is mounted; and
a secondary taping operation of attaching a second tape to another surface of the electrode assembly on which the primary taping operation is completed.

17. The method for taping the electrode assembly of the battery as claimed in claim 16, wherein:
the electrode assembly includes an upper end surface portion on which the terminal part is located, a lower end surface portion located at a side opposite to the upper end surface portion, a first surface portion and a second surface portion formed between the upper end surface portion and the lower end surface portion and parallel to one another, and two side surface portions located between the first surface portion and the second surface portion and parallel to one another,
the primary taping operation is a process of attaching the first tape to the first surface portion and portions of the two side surface portions, and
the secondary taping operation is a process of attaching the second tape to the second surface portion and portions of the two side surface portions.

18. The method for taping the electrode assembly of the battery as claimed in claim 17, wherein the first tape and the second tape partially overlap one another on the two side surface portions.

19. The method for taping the electrode assembly of the battery as claimed in claim 16, further comprising a forming operation of attaching the first tape and the second tape to a lower end surface portion of the electrode assembly.
